(19) United States
(12) Patent Application Publication
(10) Pub. No.: US 2025/0373418 A1
(43) Pub. Date: Dec. 4, 2025

(54) Method for generating encryption using graph theory and geometric curves.

(71) Applicant: Leith Tidwell, Provo, UT (US)

(72) Inventor: Leith Tidwell, Provo, UT (US)

(73) Assignee: Leith Tidwell, Provo, UT (US)

(21) Appl. No.: 18/680,992

(22) Filed: May 31, 2024

(51) Int. Cl. H04L 9/08

(52) U.S. Cl. CPC H04L 9/0861

(57) ABSTRACT

The present invention is a method for generating encryption using graph analysis to create geometric curves. This method increases the strength of encryption keys while maintaining reduced time complexity.

### FIELD OF THE INVENTION

The present method invention relates to the field of cryptography and encryption of data.

### BACKGROUND OF THE INVENTION

Cryptography is developed from the idea the key you use to encrypt data can be shared publicly and executed privately. This cryptography requires a series of equations easy to execute but difficult to reverse. The difference between ease in executing a method in one direction and difficulty in reversal of the method is considered the overall strength of a cryptographic system. Most current cryptographic systems utilize either multiplication of random numbers with the strength of encryption depending on the difficulty of factoring or breakdown of the multiplication or the generation of an encryption key using graphical curve equations for random variables. Modern electronic systems have reduced ability to process large numbers which limits the potential length of encryption keys available to cryptographic systems.

### DESCRIPTION OF THE INVENTION

The present invention method increases the strength of encryption while reducing time complexity needed for computation. This is accomplished using the following methods:
1) generate parabolas using a random number set:
   a) obtain random number set for vertices by using hyperbolic random number generator with every fourth number a negative value.
   b) use the vertex parabolic equation to generate graph with random numbers obtained from hyperbolic number generator for variables.
   c) use factored parabolic equation to generate graph using next random number set.
   d) use negative standard parabolic equation to generate graph using next random number set.
   e) use vertex parabolic equation to generate graph using next random number set.
2) identify best-connected nodes on each parabolic graph:
   a) depth-first search of parabolas.
   b) topological sorting of parabolas using number points as nodes to the fiftieth node.
   c) extract strongly-connected components of parabolas to the fiftieth node.
   d) use breadth-first traversal to find the all-pairs shortest path between connected graph points.
3) use closest connected nodes between graphs to create a plane curve over a finite field using Edwards curve equations.
a) use curve equations to create plane curves over a finite field using coordinate groups from breadth-first traversal for encryption key generation.

### Example Embodiments

The present invention can use equations, graphs, and curves to establish an encryption key. These include, but are not limited to, vertex and factored forms of the parabolic equations, depth-first search methods, breadth-first search, and enablement of finite curves.

### Objects and Advantages

A new method of encryption is created which allows users to strengthen data protection through graph randomization while maintaining limited time complexity for computation. This method gives users stronger encryption without requiring either increased computational ability or time requirements.

1. The present invention is a method for strengthened cryptographic systems using randomly generated strongly-connected graphs and finite curves in encryption key generation. This method increases cryptographic complexity while reducing technological requirements.
